(19) United States
(12) Patent Application Publication
(10) Pub. No.: US 2022/0371237 A1
(43) Pub. Date: Nov. 24, 2022

(54) ORGANIC POLYMER PROCESSING

(71) Applicant: CRUZ FOAM, INC., Santa Cruz, CA (US)

(72) Inventors: Matthew JOHNSON, Santa Cruz, CA (US); John FELTS, Santa Cruz, CA (US); Xiaolin ZHANG, San Jose, CA (US)

(73) Assignee: CRUZ FOAM, INC., Santa Cruz, CA (US)

(21) Appl. No.: 17/773,514

(22) PCT Filed: Oct. 26, 2020
(86) PCT No.: PCT/US20/57373

§ 371 Date: Apr. 29, 2022

Related U.S. Application Data
(60) Provisional application No. 62/928,243, filed on Oct. 30, 2019.
(60) Provisional application No. 62/928,252, filed on Oct. 30, 2019.

(51) Int. Cl. B29C 44/56; B29C 44/02; B29C 48/00; C08J 9/228

(52) U.S. Cl. CPC B29C 44/5636; B29C 44/02; B29C 48/0012; C08J 9/228; B29K 2105/04

(57) ABSTRACT

A method of forming foam includes providing a foam with at least one of chitosan, chitin, or chitosan oligosaccharide, where the foam has a density of 1 g/cm³ or less. The method further includes placing the foam between tooling, applying heat to the foam, and pressing the foam into a shape using the tooling.

### CROSS-REFERENCE TO RELATED APPLICATIONS

This application claims the benefit of U.S. Provisional Application Nos. 62/928,252, filed Oct. 30, 2019; and 62/928,243, filed Oct. 30, 2019, which are hereby incorporated by reference.

### TECHNICAL FIELD

This disclosure relates generally to polymer processing.

### BACKGROUND INFORMATION

Petroleum-based plastic foam is ubiquitous in modern society: it is used for packaging, flotation, and the like. However, petroleum-based plastic foam suffers from many drawbacks. For example, the ocean has become filled with petroleum-based foam waste. This is because many petroleum-based foams, such as polystyrene foam take 500 years or more to decompose. Moreover, petroleum-based plastic foams are either entirely non-recyclable (because of their chemical composition) or not economically viable for recycling due to the low material content of the foam: petroleum-based foams are mostly air.

Petroleum-based foams tend to be toxic or made by toxic processes. Although petroleum-based foams resist decomposition, when the foams do decompose, decomposition can result in the release of toxic compounds into the environment (e.g., degraded monomer units of the foam). Furthermore, polystyrene (and other petroleum-based foams) is made using toxic chemicals such as benzene and styrene, which have been shown to be carcinogenic and slowly leach into the environment and food products in contact with the foam.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates an example of biodegradable foam, in accordance with an embodiment of the disclosure.

FIG. 2 illustrates the chemical structure of chitin and chitosan, in accordance with an embodiment of the disclosure.

FIG. 3A illustrates a method of thermoforming biodegradable foam, in accordance with an embodiment of the disclosure.

FIG. 3B illustrates a method of thermoforming biodegradable foam, in accordance with an embodiment of the disclosure.

FIG. 3C illustrates a product made from thermoforming biodegradable foam, in accordance with an embodiment of the disclosure.

FIG. 3D illustrates a product made from thermoforming biodegradable foam, in accordance with an embodiment of the disclosure.

FIG. 3E illustrates a product made from thermoforming biodegradable foam, in accordance with an embodiment of the disclosure.

FIG. 3F illustrates a product made from thermoforming biodegradable foam, in accordance with an embodiment of the disclosure.

FIG. 3G illustrates a product made from thermoforming biodegradable foam, in accordance with an embodiment of the disclosure.

FIG. 4A illustrates a foam extrusion system and method, in accordance with an embodiment of the disclosure.

FIG. 4B illustrates a foam extrusion system and method, in accordance with an embodiment of the disclosure.

FIG. 5 illustrates a coating on the organic composite foam of FIG. 2, in accordance with an embodiment of the disclosure.

FIG. 6 illustrates a method of making foam to be thermoformed, in accordance with an embodiment of the disclosure.

FIG. 7 shows a table of measured foam properties, in accordance with an embodiment of the disclosure.

### DETAILED DESCRIPTION

Embodiments of organic polymer processing techniques are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As stated above, petroleum-based foams suffer from many drawbacks. Described herein are biodegradable foams, biodegradable foam devices, and systems, apparatuses, and methods for producing the biodegradable foams that solve the problems associated with conventional petroleum-based foams. The foams described herein are biodegradable, nontoxic, and produced with nontoxic precursors and through environmentally friendly processes. As will be shown, these biodegradable foams represent a significant advancement over existing industrial foam technologies since the biodegradable foams have similar or better mechanical, chemical, and thermal properties than the petroleum-based foams, with none of the negative environmental impact.

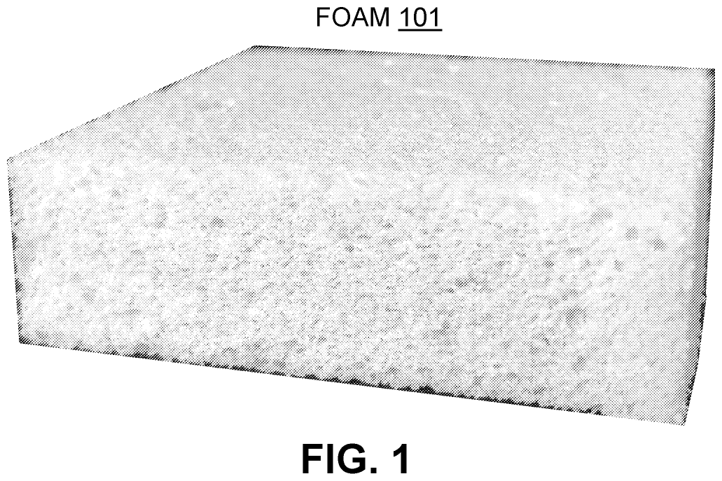

FIG. 1 illustrates foam sample 101, in accordance with an embodiment of the disclosure. Foam sample 101 may include any of chitosan, chitosan oligosaccharide, chitin, and may include other materials. When foam sample 101 includes multiple constituent components it may be referred to as a composite (e.g., a material made from two or more constituent materials). The composite foam material 101 may include a matrix including a polymer (e.g., chitosan, or chitin) including monomer units of D-glucosamine and N-acetyl-D-glucosamine. In the depicted embodiment, the polymer may include 70% or less N-acetyl-D-glucosamine; however in other embodiments, the polymer may include 60% or less N-acetyl-D-glucosamine, 50% or less N-acetyl-D-glucosamine; 40% or less N-acetyl-D-glucosamine, 30% or less N-acetyl-D-glucosamine, 20% or less N-acetyl-D-glucosamine, or 10% or less N-acetyl-D-glucosamine. A dispersed phase may be disposed in the polymer matrix, and the dispersed phase and the polymer matrix form porous composite foam 101. In the depicted embodiment, porous composite foam 101 includes a ratio of 0.5-3 of the dispersed phase weight to the polymer matrix weight, and has a density of less than 1 g/cc. For some composite foam embodiments, a ratio of about 0.5 to 2.5 of the dispersed phase weight to the polymer matrix weight is utilized. In general, the ratio should be at a level effective to maintain structural integrity of the composite foam.

In some embodiments, the dispersed phase includes at least one of chitin, starch, or cellulose. More specifically, examples of dispersed phases may include at least one of (unprocessed or minimally processed) shellfish shells, wood flour, hemp, paper pulp (e.g., including broken down recycled paper), coconut husks, cornstarch, tapioca powder, or the like. It is appreciated that foam 101 depicted, has been made with all of the aforementioned dispersed phases, and that the dispersed phases are not mutually exclusive (the dispersed phases can be used individually and in combination). For example, all of the dispersed phases mentioned above may be combined in the same piece of composite foam 101, or only some of the dispersed phases may be included in the same piece of composite foam 101.

Foams made from chitosan, chitosan oligosaccharide, and chitin are biodegradable and have none of the toxic qualities of petroleum-based foams described above. The discovery of adding a chitosan-compatible dispersed phase to the foam is a significant advancement in biodegradable foam technology because the properties of the foam can be tuned for a variety of applications. One can tune the pore size for example, by using a closed-mold during heating and changing the pressure inside the mold. By increasing the internal pressure, foams with smaller pore sizes can result. One can tune the density of the foam for example, by (1) changing the amount dispersed phase material and the amount of blowing agent (less dispersed phase material, more blowing agent, lower foam density), or (2) optimizing the internal pressure and temperature of the closed-mold (lower pressure, higher temperature, lower foam density). Indeed, the dispersed phases may enhance the mechanical properties of the foam by carrying part of applied loads (e.g., in tension, strain may be imparted to the dispersed phase—e.g., fibers—in the foam and not entirely carried by the polymer matrix). Furthermore, using biodegradable waste products, which may be locally sourced, reduces the cost of foam production. Dispersed phases may not totally dissolve in an acid solution, which may be used to make the foam, and may be distinct from the polymer matrix in the resultant foam (e.g., adhered to the polymer matrix but separate—not dissolved—in the polymer matrix).

In some embodiments, a nontoxic (e.g., safe for human consumption, safe for human skin contact, not generally regarded as carcinogenic, or the like) plasticizer may be disposed in the matrix material to impart a flexible character to the foam. Thus, foam sample 101 may be deformed (e.g., compressed, bent, stretched, or the like) and return to its original form without breaking. In some embodiments, the nontoxic plasticizer may include low molecular weight polymers, polyols, alcohols, or the like. In one embodiment, a polyol that is used as a plasticizer may be glycerol, and glycerol may be added from 0.0001 vol % to 50 vol % (relative to the other ingredients in the final foam) depending on the target foam flexibility. In one embodiment, a dye may be added to the polymer matrix, and the dye (e.g., food colorings or other nontoxic dyes) imparts a color (e.g., red, green, blue, yellow, orange, etc.) to the porous foam 101. It is appreciated that this color is not amenable to illustration due to the black and white nature of the drawings.

To produce the specific embodiment of foam sample 101 shown in FIG. 1, a solution of 0.5 M acetic acid (CH3COOH) was prepared with deionized water. Chitosan was dissolved in this solution at 4% w/v. The solution was stirred until the chitosan was fully (or partially) dissolved and clear. Corresponding amounts of starch (e.g., a dispersed phase; 0.1-0.2 wt ratio relative to chitosan dissolved in solution), chitin powder (e.g., a dispersed phase; 0.5-2.5 wt ratio relative to chitosan dissolved in solution), and sodium bicarbonate (0.5-1.5 wt ratio relative to the chitosan dissolved in solution) were added to the solution. The mixture underwent vigorous stirring. The mixture was then poured into a mold (which may be fully closed or open) and heated (in the mold) at 200400° F. for 1-1.5 hr depending on the thickness of the final sample. In some embodiments, the mold may have heaters built into it. When heating was completed, the foam was transferred to a dehydrating oven to remove remaining moisture. The mixture then was placed into a vacuum chamber for 12 hrs. After vacuum, the foam was transferred to a drying container and underwent a 24-hr air-dry.

With this method, the resulting foam is fully dried. In this specific embodiment, the foam has a density that can be tuned between 0.1-0.8 g/cc with varied pore size and porosity. This foam includes chitin and a residual amount of sodium acetate (NaC2H3O2) and starch, all of which are nontoxic, biodegradable, and compostable. In other embodiments, other salts (e.g., not sodium acetate) may be left in the foam. As shown on the left, the cross-section of the foam reveals a uniform cellular structure. In the depicted embodiment, the average pore size can be tuned from 200 um-800 um. In some embodiments, the matrix polymer may be substantially chitosan (e.g., chitosan with some impurities), >90% chitosan, >80% chitosan, >70% chitosan, >60% chitosan, >50% chitosan, or the like depending on the desired mechanical properties and purity of chitosan used as a source for the foam.

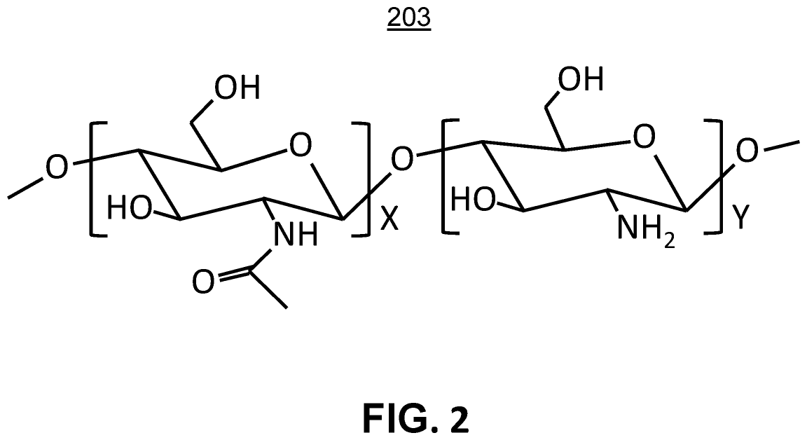

FIG. 2 illustrates the chemical structure 203 of a polymer which can be characterized as chitin or as chitosan depending on the relative amounts of blocks X (with acetyl group) and block Y (with amine group) in the chain (which may be used in the foam of FIG. 1), in accordance with an embodiment of the disclosure. Deacetylation replaces the N-acetyl-glucosamine group in chitin (X block) with an N-glucosamine (Y block) resulting in a more hydrophilic and positively charged polymer, which can be described as partially deacetylated chitin. Alternatively, acetylation of chitosan can yield a partially acetylated chitosan. When the ratio between acetyl and amine groups is higher than 1:1 (x>y; greater than a 50%/50% split of the two monomer units), the partially deacetylated chitin polymer may be referred to as chitin, when the ratio is lower, the partially acetylated chitosan polymer may be referred to as chitosan. Put another way, chitosan has 50% or more N-glucosamine groups, whereas chitin has more than 50% N-acetyl-glucosamine groups. Chitosan oligosaccharide has the same molecular structure depicted, just with a lower molecular weight (fewer monomer units) than the polymers of chitin or chitosan. In some embodiment, chitosan oligosaccharide may be dissolved in acid as described elsewhere in connection with the processing of chitosan. Chitin may be dissolved using a strong base (e.g., NaOH) and mixed with an acid (as detailed elsewhere herein) to form a salt.

The relative concentrations of the acetyl and amine groups in a polymer can be measure for example using techniques described in Shigemasa, et al, “Evaluation of different absorbance ratios from infrared spectroscopy for analyzing the degree of deacetylation in chitin,” International Journal of Biological Macromolecules 18 (1996) 237-242, which is incorporated by reference as if fully set forth herein. Density of a foam may be measured using the formula “mass/volume=density”, where volume can be measured using water displacement or the like, and mass can be obtained using a scale. In order to determine the amount of dispersed phase relative to the polymer matrix or other ingredients in a foam sample, the polymer matrix may be dissolved away (e.g., using a solvent like acid) and the remaining ingredients may be measured (e.g., by weight or volume or the like). For example, the different components in the foam may be dissolved in a solvent that the component is uniquely soluble in, and then the component may be separated from the solvent (e.g., by evaporating the solvent away) and measured (e.g., by weight or volume or the like). Different ingredients may also be separated out of the foam mixture by melting (due to different melting points of the foam ingredients) and measured. One of skill in the art having the benefit of the present disclosure will appreciate that there are numerous (too many to effectively list here) chemistry techniques for separating mixtures that may be used to measure the various constituent components of a foam sample.

Through experimentation it has been shown that processing of chitosan and chitin is very different, and the use of chitosan in the foam process results in different structures with different material properties than foams with a chitin matrix. For example, the solubility of chitin and chitosan in solvents is dissimilar, and accordingly, procedures for foaming, adding a dispersed phase, and heating/hardening are very different. Thus, the final chitosan foam is distinct from foams made from chitin, and the processes used to make the chitosan-based foam may not be applicable to making chitin foams. Similarly, processes to make chitin foams may not be applicable to making the foam disclosed herein.

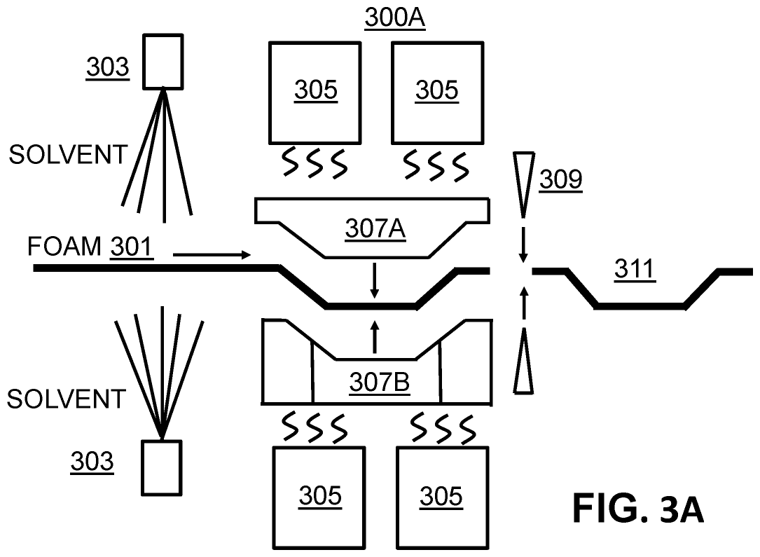

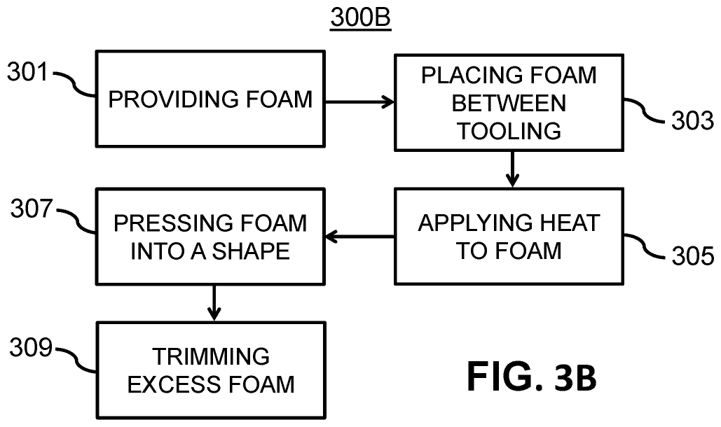

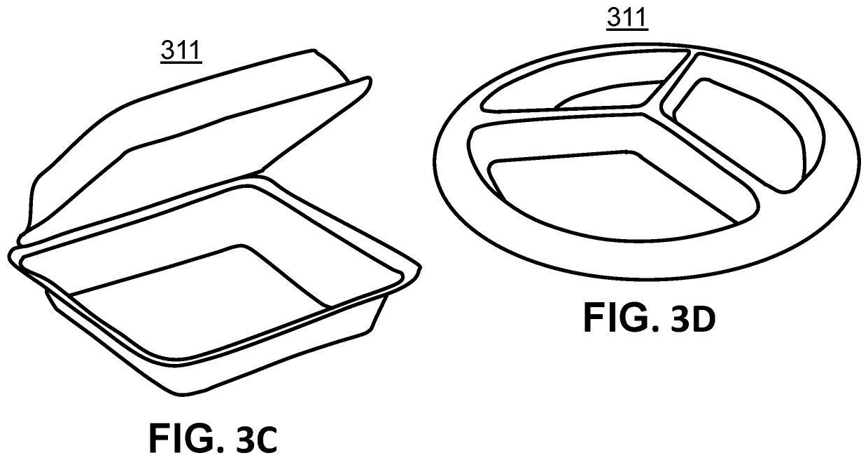

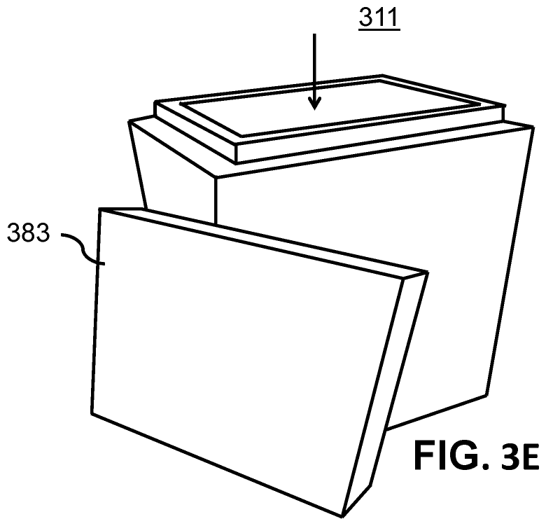

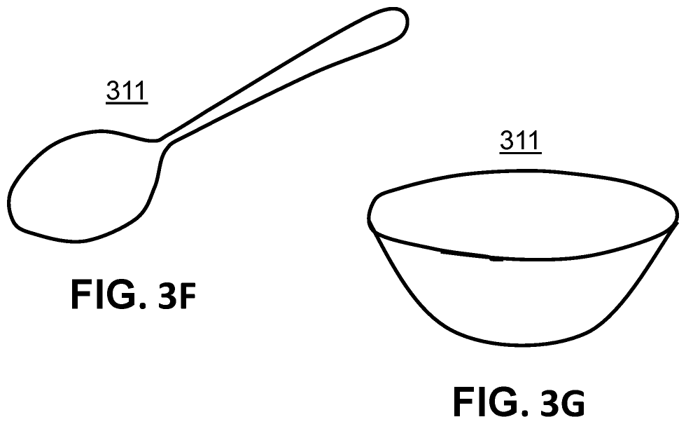

FIG. 3A illustrates a thermoforming system and method 300A, in accordance with an embodiment of the disclosure. Thermoforming is a manufacturing technique where a sheet of material may be heated to a temperature where the material becomes pliable, and then the material is pressed into a desired shape using a mold. In some embodiments, the formed material is trimmed after pressing to remove excess material. In some embodiments, steam (e.g., water or other solvent) as well as heat (e.g., 50-500 degrees Fahrenheit) may be applied to the material to make the material more pliable (e.g., by heating the material to a glass transition temperature or melting temperature). In some embodiments, vacuum may, in whole or part, be used to press the sheet of material against the sides of the mold. In some embodiments, a sheet of biodegradable foam (e.g., foam 101 of FIG. 1 or other foam formulations described herein) is formed, in the manner described above, using heat, steam (or both) to make a variety of products.

Thermoforming may be conducted using the specific foam compositions described herein, and others not described. One of skill in the art will appreciate that the various embodiments can be combined in any suitable manner to produce malleable formable foam suitable for thermoforming.

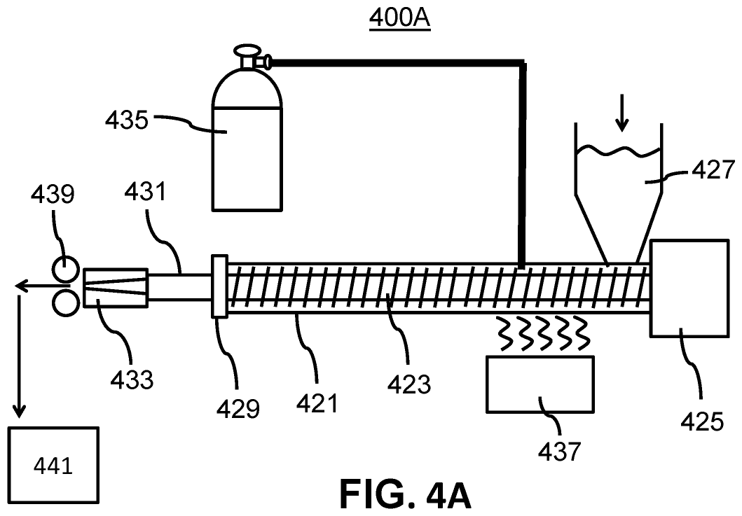

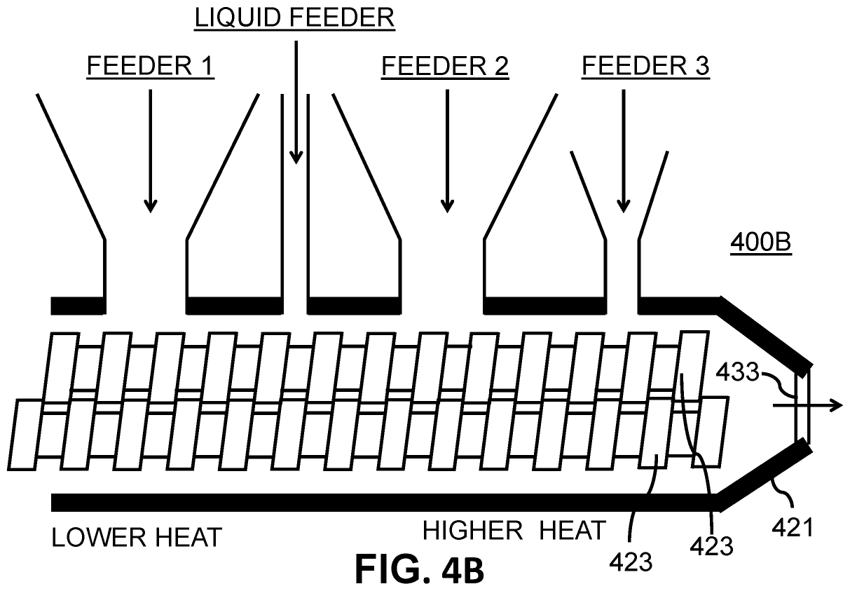

In the depicted embodiment, a continuous sheet of foam 301 (e.g., with the chemical compositions described above, or others not described) is received (e.g., from a spool or from an extruder process (e.g., depicted in FIGS. 4A and 4B and discussed herein). Foam 301 is heated and steam (and/or other solvents like ethanol) is introduced with vapor introduction devices 303 (e.g., water heater such as commercial steaming device, kettle with boiling water, nozzle spraying hot solvent, or the like).

Foam sheet 301 is placed on or between the male 307A and female 307B dies (e.g., an embodiment of tooling in the thermoforming system that presses the foam into the desired shape). Dies 307A/307B may have male and female shaped parts such that when foam 301 is pressed between dies 307A/307B the foam is formed into the shape of a plate, clamshell box, or the like. Dies 307A/307B may be heated with heaters 305 thermally coupled to provide heat to dies 307A/307B. In some embodiments heaters 305 may be steam passed through channels in dies 307A/307B, resistive coils coupled to dies 307A/307B, or the like. In some embodiments, vacuum may be applied to the foam (e.g., though holes in the dies, depicted as lines in die half 307B) so foam is conformal with the surface of die 307B. A vacuum pump coupled to die 307B may pull vacuum on the holes in die 307B.

Dies 307A/307B are pressed together to apply heat (e.g., 325° F. or other temperatures depending on foam composition and desired end shape), and pressure to foam 301 for a period of time (e.g., one or more seconds or other time depending on foam composition and desired shape).

The dies 307A/307B are separated and the foam product 311 (e.g., disposable plate, or clam shell packaging) is removed from the die halves 307A,307B. The flashing (i.e., extra material) is cut away from the usable part (e.g., with blades 309). In the depicted embodiment, foam 301 is a continuous sheet that is fed into system 300A; accordingly, blades 307 also cut foam 301 to separate foam product 311 away from the continuous sheet of foam 301.

In some embodiments, the products 311 made using the depicted process may be one directional (e.g., pressed in one direction), have sufficient draft angles to prevent tearing of foam 301, and are not so deep as to cause problems with the foam 301 forming to the mold/die 307A/307B. Any shape that could be made in either a vacuum former or other thermoformer, could be made using the biodegradable foam 301 and the thermo/steam forming process described herein. A non-exhaustive list of items that may be made includes: plates; bowls; clamshells containers; utensils, and candy trays.

FIG. 3B illustrates a method 300B of thermoforming biodegradable foam, in accordance with an embodiment of the disclosure. One of ordinary skill in the art having the benefit of the present disclosure will appreciate that the blocks depicted (e.g., blocks 301-309) may occur in any order and even in parallel. Moreover, blocks may be added to, or removed from, method 300B in accordance with the teachings of the present disclosure. Method 300B may be carried out, at least in part, with a controller or processor (e.g., general purpose computer or application specific integrated circuit) coupled to the thermoforming equipment. And the controller or processor includes logic (e.g., instructions, code, or the like in memory such as ROM or RAM) that when executed causes the thermoforming equipment to perform the operations described below.

Block 301 shows providing foam including at least one of chitosan, chitin, or chitosan oligosaccharide. In some embodiments, the polymer matrix of the foam includes the chitosan, chitin, or chitosan oligosaccharide. In the same or a different embodiment, a dispersed phase is disposed in the polymer matrix, and the dispersed phase may include at least one of chitin, starch, or cellulose. In some embodiments, the foam may include at least one of a sodium or calcium salt.

Block 303 depicts placing the foam between tooling. Tooling my include male and female die halves in the shape of a plate, clamshell packaging, cooler or the like.

Block 305 illustrates applying heat to the foam. The foam may partially melt or soften to make it more malleable.

Block 307 shows pressing the foam into a shape with the tooling. In some embodiments the shape may include at least one of a plate, a cooler, a bowl, a clamshell container, a utensil, a candy tray, or other packaging. In some embodiments, a vapor or fluid (e.g., water or other solvent) may be applied to the foam prior to or during the pressing of the foam.

In some embodiments pressing the foam into a shape includes applying vacuum to the foam. The vacuum may be applied though holes in one side of the die or other tooling to conform the foam to the tooling. Vacuum may be generated using a vacuum pump or the like.

Block 309 depicts trimming excess foam after pressing the foam into the shape. This may be achieved by pressing a sharp edge or blade against the foam in a way to remove the excess foam or separate the shape from a larger sheet of foam.

FIG. 3C illustrates a product 311 made from thermoforming biodegradable foam, in accordance with an embodiment of the disclosure. As shown clamshell packaging (e.g., packaging used in carry out food or the like) is formed. In some embodiments, product 311 (and any of the products depicted in FIGS. 3C-3G) may be coated with materials described elsewhere herein and other coatings not described. This way product 311 better withstands contact with moisture in food or the like. In some embodiments, the coating makes the foam mostly impermeable to water. It is appreciated that both chitin and chitosan are insoluble in water; accordingly, the products and foams disclosed herein may also be insoluble in water, making them good choices for food handling or other wet environments.

FIG. 3D illustrates a product 311 made from thermoforming biodegradable foam, in accordance with an embodiment of the disclosure. As shown a disposable plate, with three separate sections, was formed. In the depicted embodiment, the plate may be a majority (>50% by weight) chitosan or chitin due to these materials' insolubility in water.

FIG. 3E illustrates a product 311 made from thermoforming biodegradable foam, in accordance with an embodiment of the disclosure. As shown a cooler 311 and a separate lid 383 were both formed using the thermoforming process. In some embodiments, cooler 311 and lid 383 may also be made from a majority (>50% by weight) chitosan or chitin.

FIG. 3F illustrates a product 311 made from thermoforming biodegradable foam, in accordance with an embodiment of the disclosure. As shown a utensil (spoon) was made from thermoforming. Other utensils my also be made including forks, sporks, and knives.

FIG. 3G illustrates a product 311 made from thermoforming biodegradable foam, in accordance with an embodiment of the disclosure. As shown a bowl was made from thermoforming.

FIG. 4A illustrates a foam extrusion system 400A and method, in accordance with an embodiment of the disclosure. Extrusion is a continuous process where materials are fed into the extrusion machinery, and structured extrudate (e.g., the extruded material product) is pushed out of the system in desired shapes. An extruder has several parts: feeder, extruder barrel, extruder screws, extruder drive, and die profile. Polymers may be fed into the extruder with a controlled gravitational feeder. The polymers are then transported from the start of the system along the screws at an elevated temperature within, and along the length of, the heated barrel. As the polymers are moved along the heated barrel, various additives and blowing agents can be added into the system. This continuous movement allows materials to mix well, forming a uniform viscous mixture, which then goes through a die profile at the end/output of the extruder. Extrusion manufacturing is a high throughput process. Depending on the specific die design (e.g., the shapes and dimensions of the opening that the materials will be pushed out of), the final extrudate can be in various forms, like rolls, tubes, sheets, planks, and other customized shape profiles. Compared to batch processing, extrusion is less expensive, and the extrudates have consistent properties since batch-to-batch variances are eliminated.

Foam extrusion system 400A includes barrel 421, screw 423, drive motor 425, input 427 (e.g., input for the mixture; depicted here as a “hopper”), breaker plate 429, feed pipe 431, die 433, foaming agent(s) in cylinder 435, heating unit 437, puller 439, and dehydrator 441. As illustrated a mixture is provided (in input 427 or other inputs depicted elsewhere) and the mixture includes a polymer, acid, dispersed phase, and water. The polymer may include monomer units of D-glucosamine and N-acetyl-D-glucosamine, with 70% or less N-acetyl-D-glucosamine monomer units. In some embodiments, the mixture further includes a plasticizer (preferably nontoxic e.g., a polyol like glycerol) to impart a flexible character and in some embodiments an elastic character, to the porous composite foam. Similarly, in one or more embodiments, the dispersed phase includes at least one of chitin, cellulose, or starch (e.g., at least one of shellfish shells, wood flour, paper pulp, corn starch, coconut husks, tapioca powder, or the like). As will be discussed in greater detail later, in some embodiments, the mixture further includes an alcohol (e.g., ethanol, methanol, butanol, or the like). As shown, the mixture is inserted into the input 427 of the extrusion system 400A, where it is fed into barrel 421.

Extrusion system 400A pushes the mixture through one or more barrels 421—only one barrel 421 is depicted here, but one of skill in the art having the benefit of the present disclosure will appreciate that additional barrels may be coupled in series in accordance with the teachings of the present disclosure—with one or more screws 423 disposed in one or more barrels 421. As shown, the one or more screws 423 are coupled to one or more motors 425 to turn one or more screws 423, which push the mixture forward

In the depicted embodiment, a foaming agent (e.g., contained in cylinder 435) is input (via a foaming agent input pipe) into extrusion system 400A to be received by the mixture, and foam the dispersed phase and the polymer matrix into the porous composite foam. In some embodiments, the foaming agent includes at least one of sodium bicarbonate, sodium carbonate, calcium carbonate, or carbon dioxide. In the depicted embodiment, heating unit 437 applies heat (depicted as wavy lines above heating unit 437) proximate to the input of extrusion system 400A.

Once the foam reaches the end of extrusion system 400A a shape of the porous composite foam is output from die 433. The shape has a fixed cross-sectional profile (e.g., circular, square, rectangular, hexagonal, or the like). Puller 439 is positioned to receive the foam from die 433 and keep a constant tension on the foam being removed from the system. Tension may be achieved by having the rollers of puller 439 being engaged by a motor to turn the rollers and pull the foam from die 433. Dehydrator 441 may receive the foam, and dehydrator 441 may heat the foam or pull vacuum (e.g., reduce the pressure) on the foam to remove excess solvent.

As stated above, in some embodiments, ethanol may be introduced as a co solvent, and can facilitate vapor evaporation of solvent for an extrusion-based foam manufacturing process. Ethanol is added into water at a volume fraction of 1%-90% (VEtOH:VH20=1:99-1:9). Then, acetic acid may be added to the mixture, to keep the pH at around 4.6 (a general range of pH 4-5), which allows deacetylated chitin (chitosan) (1-100% w/v) to dissolve in this solvent system. Then the chitin (or other) dispersed phase is added to the mixture (e.g., 0.5-2.5 wt ratio against chitosan dissolved in solution) along with sodium bicarbonate (1:1 mol ratio against acetic acid in the solvent system) as the blowing agent to neutralize the acid in the mixture. Due to the evaporative nature (e.g., lower boiling point than water) of ethanol, this foam mixture has higher viscosity, and can go through a heated extruding pipeline with controlled flow rates for an extrusion process. After the foam is extruded out of the extruder, it hardens quickly, and forms a foam block. This block may then be left overnight for a curing process which allows the excess solvent to evaporate. Ethanol is a feasible choice here as a co solvent with water, since it is miscible with water and acetic acid. This formula facilitates vapor evaporation during foam manufacturing and will increase the production turnaround. Also, due to the decreased volume of water in the initial mixture, the cellular structure of the foam can be improved due to the reduced amount of water vapor evaporation, which leads to enhanced process controllability.

To summarize one embodiment, a highly viscous dough-like mixture (e.g., including chitosan) may be made. Chitin or a combination of chitin/chitosan and paper pulp, corn starch, tapioca powder, coconut husks, wood flour, or any other dispersed phase may be added. The highly viscous dough like mixture is moved into extrusion system 400A at high temperature, and sodium bicarbonate (and/or other forming agents; e.g., CO2 may be added as needed via a nozzle) is input into extrusion system 400A. The mixture is extruded at a high temperature and/or high pressure from an appropriately shaped nozzle into atmospheric pressure (lower pressure). As a result, the extruded material will expand. The foam may then be cured (e.g., in dehydrator 441) at high/medium temperature as needed to remove excess water and other solvents.

FIG. 4B illustrates a twin-screw extrusion system 400B and method, in accordance with an embodiment of the disclosure. Here a set of formulations and extrusion parameters were developed to extrude biodegradable foam using the twin-screw 423 extruder (“TSE”) 400B depicted. In the illustrated embodiment, there are a plurality of separate input feeds (e.g., gravitational feeders) for solids (feeder 1, 2, 3), as well as a liquid feed which is driven by a pump. These inputs may be disposed along a length of barrel 421 at various intervals. Solid and liquid components may be input through separate feeds, each feed with its own material or a mix of materials. The extrusion feeder set up is set forth here: feeder 1—chitosan, chitosan oligosaccharide, or chitin; feeder 2—chitin, starch cellulose, other dispersed phase materials, feeder 3—salt, e.g., sodium bicarbonate or calcium carbonate; and liquid feed—acid solution (e.g., 0.1-10% volume acetic acid to water). It should be noted that FIG. 4B depicts a cartoon cross section of TSE 430B that is not drawn to scale; indeed, the relative distances between input feeds, and length of screws 423 may be distorted, as actual dimensions are not amenable to illustration.

To produce a specific embodiment of extruded foam (e.g., the embodiment depicted in FIG. 2 shown in U.S. provisional application 62/928,243 incorporated by reference herein), a solution of 5 vol % acetic acid (CH3COOH) was prepared with water and fed into the extrusion system via liquid feed. Chitosan (or chitin or chitosan oligosaccharide) was loaded in feeder 1, cornstarch (an example of a dispersed phase) in feeder 2, and sodium bicarbonate (an example of a salt) in feeder 3. The extruder barrel 421 was pre-heated in an arranged temperature profile beginning at 20° C. around feeder 1, the temperature increases to 50° C. at before feeder 3, the temperature further increases to 75° C. at feeder 3, and the temperature is further increased to 140° C. by the end of TSE 430B near die 433. The materials were added in for following order: (1) the TSE 400B was started with the liquid feed to make sure the machinery works smoothly, (2) cornstarch was added to feeder 3, and (3) chitosan was added in feeder 1. The sodium bicarbonate feed (feeder 3) was turned on when TSE 430 output stabilized. Each feeder may start with a relatively small feed rate and ramp up slowly so that the system reaches equilibrium. This way the extrudate is produced in a continuous flow. Extrudate foam may include the dispersed phase and at least one of chitin, chitosan, or chitosan oligosaccharide. When the extrudate gets pushed out of die 433, it generally has a moisture content (“MC”) less than 20%. This MC then drops down further when the foam is left at room temperature and humidity for several hours. After the rest period at room temperature/humidity, the foam is completely dry depending on output shape and dimensions.

In the same embodiment, the foam has a density that can be tuned between 0.05-0.8 g/cc with varied pore size and porosity. The final foam includes chitin, starch, and sodium acetate (NaC2H3O2), all of which are nontoxic, biodegradable, and compostable. In other embodiments, other salts (e.g., salts that may result from any acid base combination) may be left in the foam. In some embodiments, the matrix polymer may be substantially chitosan (e.g., chitosan with some impurities), >90% chitosan, >80% chitosan, >70% chitosan, >60% chitosan, >50% chitosan, or the like depending on the desired mechanical properties and purity of chitosan received.

In some embodiments, extrusion parameters such as barrel 421 temperature in each heating zone (e.g., a plurality of zones defined along the length of the barrel 421, each with independently controlled heating systems), as well as feed rates for solid and liquid components may be tuned. These parameters may affect the extrudate chitin/chitosan-based composite foams. TSE 430B used for this specific foam embodiment has 10 separate heat zones along barrel 421 (with higher numbers referred to here being sequentially closer to the die/end of TSE 430B), which can be controlled independently. The temperature profile used in one embodiment is as follows: zones 1-5, 20° C.; zone 6, 50° C.: zone 7, 75° C.; zone 8, 100° C.; zone 9 120° C.; zone 10, 140° C. The temperature setting for chitin-based composite foam manufacturing is not limited to the temperatures listed, and each barrel 421 may be tuned from room temperature (˜20° C.) to 200° C. depending on the desired properties of the foam extrudate.

A number of formulations have been demonstrated feasible by tuning the setting and feed rates of TSE 430B. As the chitosan feed rate was increased from 3 lb/hr to 20 lb/hr (while keeping all other parameters constant: corn starch feed rate at 25 lb/hr; acetic acid and water feed rate at 5 L/hr; sodium bicarbonate feed ate at 1.5 lb/hr and screw 433 speed at 300 rpm) the extrusion system was stable, and continuously working. When more chitosan was present in TSE 430B, the extrudate foam may have a higher density, with higher compressive strength. However, due to the lower moisture content (relative to the other ingredients) in the foam mixture inside the extruder barrel 421, a 20 lb/hr chitosan feed rate resulted in extrudate foam that has larger pore sizes and rougher surface finish, compared to 5 lb/hr chitosan feed rate and 14 lb/hr chitosan feed rate. With an overnight drying at room temperature and room humidity, the extrudate foam is dried completely with no significant visual change.

In another embodiment the starch (one embodiment of a dispersed phase) feed rate was tuned by increasing the corn starch feed rate from 25 to 35 lb/hr (approximately 3-4.5 times the amount of chitosan input into the extruder). The chitosan feed was kept at 8 lb/hr, the acetic acid and water feed rate was kept at 5 L/hr, the sodium bicarbonate feed rate was kept at 1.5 lb/hr and, screws 433 were turned at 200 rpm. Unlike increasing the chitosan feed rate, when increasing the starch feed rate, the extrudate foam may have a lower density. Compared to 25 lb/hr cornstarch feed rate, the foam produced at 35 lb/hr feed rates is significantly lighter. This is likely due to a pressure increase within the extruder barrel 421, which then leads to higher expansion at the die 433.

In another embodiment, screw 433 speed was increased from 200 to 600 rpm, while keeping the chitosan feed rate at 8 lb/hr, the corn starch feed rate at 35 lb/hr, the acetic acid and water feed rate at 5/hr, and the sodium bicarbonate feed rate at 1.5 lb/hr. An increase in screw speed leads to increased barrel pressure, and higher expansion at die 433. This is confirmed with the extrudate foam, that foam extruded out at 600 rpm may be lighter than foam produced at 200 rpm.

In one embodiment the baking soda content was tuned. The chitosan feed was kept at 8 lb/hr, the corn starch feed rate was kept at 35 lb/hr, the acidic acid and water feed rate was kept at 5 L/hr, the screw speed was kept at 600 rpm, and the baking soda feed rate was increased from 1.5 lb/hr to 2.5 lb/hr (approximately 3%-6% of solids input to extruder). Because baking soda not only acts as a base to neutralize acetic acid in the mixture, but also as a nucleating agent, the extrudate foam may get lighter with additional baking soda. These foams may have less shrinkage when exposed to air for 3 minutes.

In one embodiment the liquid feed rate was tuned. One way to increase the pressure inside barrel 421, besides increasing screw speed or changing temperature profile, may be to increase the mixture viscosity. By increasing the solids feed rate, viscosity can be increased. Alternatively, by decreasing the liquid feed, the MC of the mixture decreases and the viscosity increases. In this embodiment the chitosan feed rate was kept at 8 lb/hr, the cornstarch feed rate was kept at 32.5 lb/hr, the baking soda feed rate was kept at 1.45 lb/hr, and the screw speed was kept at 400 rpm. The acetic acid and water feed rate was decreased from 5 L/hr to 1.9 L/hr (approximately 1 L per 20 lbs-1 L per 8.6 lbs of solids input into the extruder). When decreasing the liquid feed to 3.5 L/hr, the total MC inside drops below 20%. In some embodiments, this is an ideal range for foam extrusion. By decreasing the liquid feed even further, the extrudate foam density continues to decrease, and reaches at 0.1 g/cm3 when the liquid input is 1.9 L/hr.

Thus, as shown, the extrudate foams can have a range of density from 0.1-0.3 g/cc with a range of mechanical properties. The extrudate foam properties can further be tuned by adding additives such as polymers (e.g., polyvinyl alcohol (PVA)) to increase the foam flexibility, as well as combining the foam ingredients with other types of starch. When color additives are added, extrudate foam color can be changed (as described elsewhere herein).

The aforementioned processes and system perimeters may be completed and controlled using a controller (e.g., general purpose processor, application specific integrated circuit or the like) coupled to, or included in, the extrusion device. The controller includes logic that when executed by the controller causes the extruder to perform any of the operations described herein.

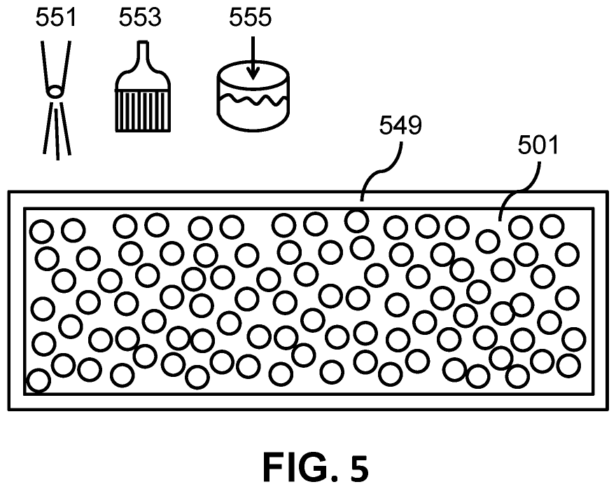

FIG. 5 illustrates a coating 549 on the organic composite foam 501 of FIG. 1, in accordance with an embodiment of the disclosure. In some embodiments, this coating may be applied to foam pre thermoforming or post thermoforming to encase the final thermoformed product. In the depicted cross section, coating 549 is disposed on the exterior of the porous (illustrated circles represent pores) composite foam 501, and the coating is substantially non-porous (e.g., it doesn't contain macro-sized holes for water to travel through: however, the coating still may be micro-porous or nano-porous).

In some embodiments, coating 549 may be applied to foam 501, by spray coating (see e.g., nozzle 551), brushing (see e.g., brush 553), dip coating (see e.g., bath 555), etc. In one embodiment, a substantially deacetylated chitin or chitosan solution (e.g., 1-4 wt % in 4% w/v acetic acid solution) is applied to all surfaces. After applying, the sample is dried in a dehydrator or oven. One of ordinary skill in the art having the benefit of the present disclosure will appreciate that the chitosan coating improves the durability of the foam in humid conditions, and also gives the foam a smooth surface finish. More specifically, coating 549 encapsulates porous composite foam 501 to prevent water ingression into porous composite foam 501. It is appreciated that in the depicted embodiment, coating 549 includes the same chemical composition (i.e. chitosan) as the polymer in the polymer matrix of foam 501. However, in other embodiments other polymer coatings 549 (e.g., polylactic acid, polyglycolide, or the like) may be applied to foam 501.

As described and depicted elsewhere herein, in come embodiments foam 501 may be output from an extruder system (see e.g., FIGS. 4A and 4B and associated discussion) and then received by a thermoforming system (see e.g., FIG. 3A and associated discussion), which may form foam 501 into one or more shapes (e.g., described and depicted elsewhere herein). In one embodiment, foam that is output from the extruder may include a chitosan polymer matrix and starch dispersed phase. In some embodiments, coating 549 may be applied to foam 501 in these processes. In one embodiment, coating 501 is applied after foam 501 is output from the extruder system, and before foam 501 is pressed into a shape. Put another way, foam 501 has a coating when it is being pressed with the thermoforming system. In some embodiments, coating 549 may be applied after pressing foam 501 into the shape. Put another way, foam 501 is pressed into a shape (e.g., the packaging described elsewhere herein) and then foam 501 is spray coated, brushed, dip coated or the like to produce coating 549.

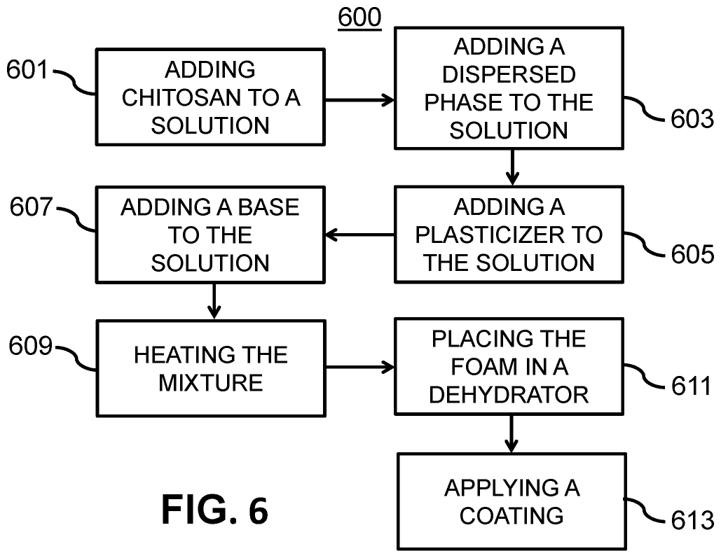

FIG. 6 illustrates a method of making foam to be thermoformed, in accordance with an embodiment of the disclosure. One of ordinary skill in the art having the benefit of the present disclosure will appreciate that the blocks depicted (e.g., blocks 601-613) may occur in any order and even in parallel. Moreover, blocks may be added to, or removed from, method 600 in accordance with the teachings of the present disclosure.

Block 601 illustrates adding chitosan to a solution, and the solution includes acid. In some embodiments, the solution including the acid has a pH of 3-6 (prior to adding the base). In some embodiments, it may be preferable to keep the pH at around 4.6 (a general range of pH 4-5)—this is advantageous over processes involving extreme pH ranges (which may use bases like sodium hydroxide or potassium hydroxide) since the processes here are much safer (no risk of burns and dangerous spills). The pH ranges recited here may be important in order to fully dissolve the chitosan. In one embodiment, the chitosan is dissolved in 0.5 M acetic acid (CH3COOH) solution at a concentration of 4% wt/v. However, in some embodiments, the acid may include at least one of acetic acid, formic acid, lactic acid, hydrochloric acid, nitric acid, sulfuric acid, or the like. In one embodiment, the solution may include water, a cosolvent (e.g., ethanol, methanol, etc.) with a lower boiling point than the water, and the acid. The low boiling point cosolvent may help reduce the time to dry the foam, since the solvent carrying the foam materials evaporates faster and at lower temperatures.

Block 603 depicts adding a dispersed phase (e.g., a phase that is composed of particles that are distributed in another phase—e.g., the polymer matrix) to the solution. In some embodiments, the dispersed phase includes at least one of chitin, cellulose, or starch. More specifically, the dispersed phase may include at least one of shellfish shells (e.g., minimally processed chitin), wood flour, paper pulp, hemp, coconut husks, corn starch, and/or tapioca powder. In some embodiments, a chitin dispersed phase is added to the mixture (e.g., 0.5-2.5 wt ratio against chitosan dissolved in solution). In some embodiments the foam may not include the dispersed phase.

Block 605 shows adding a nontoxic plasticizer to the solution, where the nontoxic plasticizer imparts a flexible character to the foam. In some embodiments, the nontoxic plasticizer includes a polyol or low molecular weight polymer (e.g., polyethylene glycol, or the like). Glycerol is a polyol with three hydroxyl groups. It is a nontoxic compound that enhances water absorption. In some embodiments, glycerol may be used as a plasticizer that is added to the chitosan-based foam formula to improve chitosan foam flexibility. The use of the plasticizer makes the foam more resistant to degradation from forces that stretch or compress the foam. When the initial deacetylated chitin (chitosan) solution in acetic acid is measured (e.g., 4% wt/v chitin in acetic acid solution), a volume percentage of glycerol (e.g., from 0.0001 vol % to 50 vol % of glycerol relative to all other ingredients in the final foam) can be added depending on the target foam flexibility. In some embodiments, depending on the specific formula for the amount of chitosan/glycerol in the mixture, the resulting foam may have a density ranging from 0.03 g/cc to 0.3 g/cc. The foam may be less rigid than chitosan foams made without glycerol and has a flexibility property similar to flexible polyurethane and expanded polypropylene, without any of the negative environmental drawbacks. However, as stated above, other plasticizers, preferably nontoxic, (e.g., other than glycerol) may be used in accordance with the teachings of the present disclosure. It is appreciated that many conventional plasticizers may be endocrine disrupters and may leach from their host plastics. The plasticizers here can be nontoxic, so this is not a problem.

Block 607 illustrates adding a base to the solution (after the chitosan and the dispersed phase is added to the solution) to foam the mixture (which includes the chitosan and the dispersed phase). The base will react with the acid in the solution to produce gasses and foam the mixture. In some embodiments, the base includes at least one of sodium bicarbonate, sodium carbonate, or calcium carbonate. Thus, a salt may result in the foam from the reacted acid and base. In some embodiments, the salt may include a sodium or a calcium salt (e.g., sodium acetate, calcium acetate, or the like). However, one of skill in the art having the benefit of the present disclosure will appreciate that the salt may be any resultant salt from the acid/base combination used to prepare the foam (e.g., any salts that result from mixing the example bases and example acids disclosed herein). In one embodiment, sodium bicarbonate (1:1 mol ratio against acetic acid in the solvent system) may be used as the blowing agent and to neutralize the acid in the mixture-no need to wash the foam since the blowing agent neutralizes the acid, thus reducing processing steps and cost. However, one of skill in the art having the benefit of the present disclosure will appreciate that other bases or foaming agents (e.g., any chemical system to produce gasses in the mixture) may be used in accordance with the teachings of the present disclosure.

Block 609 depicts heating the mixture, after adding the base, until the mixture has hardened into the foam. Heating may occur after vigorous mixing of the aforementioned ingredients. In some embodiments, the heating process may include heating the mixture in a closed or open mold. In one embodiment, the foam is heated at a constant temperature-depending on the size of the mold and the end application of the foam, the temperature may range from 180° F. to 400° F. The mold is heated until the foam is set and hardened (e.g., depending on the size of the mold and heating temperature, this heating time may range from 10 min to 3 hours).

Block 611 shows placing the foam in a dehydrator to remove water from the foam. The dehydrator may be heated and may even pull vacuum on the foam. The foam may be placed in the dehydrator overnight to allow water to fully evaporate.

Block 613 depicts applying a coating to the foam. The coating layer may be applied to the foam, by brushing/spraying/dipping/etc. with a deacetylated chitin (chitosan) solution (1-4% wt/v in 0.5 M acetic acid solution) on all surfaces and drying in dehydrator.

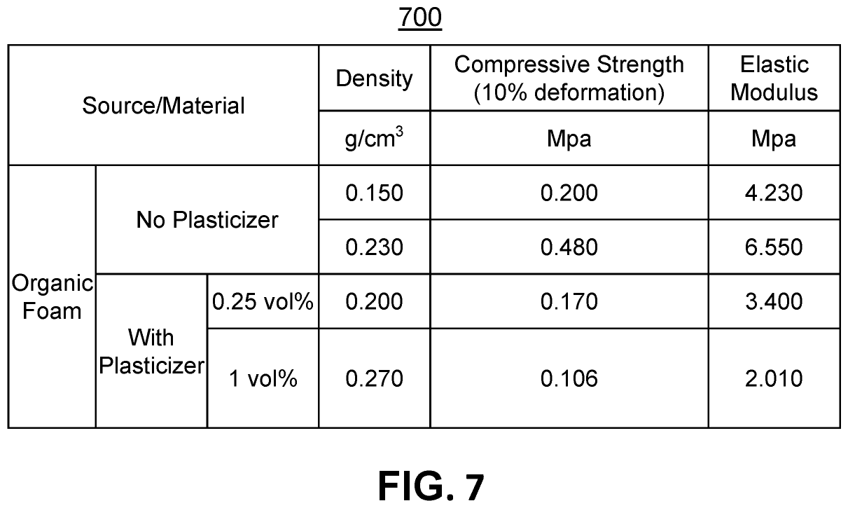

FIG. 7 shows a table 700 of measured biodegradable foam properties, in accordance with an embodiment of the disclosure. The properties are from foam samples produced in accordance with the teachings of the present disclosure. As depicted, in some embodiments, biodegradable foam produced without plasticizer has a density ranging from 0.15 g/cc-0.23 g/cc and has a compressive strength range (10% deformation) of 0.2 Mpa and 0.48 Mpa, respectively. Additionally, the foam without plasticizer has an elastic modulus ranging from 4.230 Mpa-6.550 Mpa for less dense and more dense foam, respectively. Biodegradable foam samples produced with plasticizer (e.g., glycerol) may have a 0.25 vol % (relative to all other ingredients in the final foam) of glycerol and 1 vol % glycerol, and a density of 0.20 g/cc and 0.27 g/cc, respectively. The compressive strength of these samples may be 0.17 Mpa and 0.106 Mpa, respectively. And the elastic modulous of the two samples are 3.4 Mpa and 2.01 Mpa, respectively. The data in table 700 demonstrates that foams with a wide range of material properties may be produced following the teachings of the present disclosure.

In some embodiments the foam described herein is biodegradable because it will decompose if left in moist soil, outside (so the soil has microbes, fungi, and animals to break down/consume the foam), at ˜60-80° F., for 10 weeks. In some embodiments, decomposition means that 50% or more of the polymer matrix by weight is no longer present in its initial chemical form.

Chitosan and chitin foam products, with and without dispersed phase components and with and without coatings, manufactured by extruding and thermoforming as described herein, and by other techniques such as molding, include:

Surfboard foam interior

Boat structural and filler foam

Packaging foam sheets and blocks

Package cushioning foam

Impact protection foam packaging

Thermal protection foam packaging

Medical bandage/gauze/pad

Automotive (support foam paneling)

Construction foam insulation

Furniture cushioning (pillows, chairs, mattresses)

Toys structural foam

Noise damping/sound absorbing layers, paneling and filling

Exercise equipment, including foam blocks, foam rolls, foam steps

Foam dinnerware, including plates, bowls, platters and utensils

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize. [00%] These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A method of forming foam, comprising:
providing a foam including at least one of chitosan, chitin, or chitosan oligosaccharide, wherein the foam has a density of 1 g/cm³ or less;
placing the foam on or between tooling;
applying heat to the foam; and
pressing the foam into a shape using the tooling.

2. The method of claim 1, wherein a polymer matrix of the foam includes the chitosan, chitin, or chitosan oligosaccharide.

3. The method of claim 2, further comprising a dispersed phase disposed in the polymer matrix.

4. The method of claim 3, wherein the dispersed phase includes at least one of chitin, starch, or cellulose.

5. The method of claim 1, wherein the foam includes at least one of a sodium or calcium salt.

6. The method of claim 1, further comprising applying fluid or vapor to the foam prior to or during the pressing of the foam.

7. The method of claim 1, wherein the shape includes at least one of a plate, a cooler, a bowl, a clamshell container, or a utensil.

8. The method of claim 1, wherein pressing the foam into the shape includes applying vacuum to the foam.

9. The method of claim 1, applying a coating to the foam before or after pressing the foam into the shape.

10. (canceled)

11. A method of foam extrusion, comprising:
feeding a solvent into an extruder system;
feeding at least one of chitosan, chitin, or chitosan oligosaccharide into the extruder system;
feeding a dispersed phase into the extruder system; and
outputting from the extruder system a foam, wherein the foam includes the dispersed phase and the at least one of chitosan, chitin, or chitosan oligosaccharide.

12. The method of claim 11, wherein the solvent includes acid.

13. The method of claim 12, wherein the acid includes acetic acid, citric acid, nitric acid, formic acid, lactic acid, or hydrochloric acid.

14. The method of claim 11, further comprising feeding a salt into the extruder system.

15. The method of claim 14, wherein the salt includes sodium bicarbonate or calcium carbonate.

16. The method of claim 11, wherein the extruder system includes heating zones and an end disposed proximate to a die, and wherein the heating zones proximate to the end of the extruder system have a higher temperature than the heating zones proximate to a start of the extruder system opposite the end of the extruder system.

17. The method of claim 16, wherein the heating zones are disposed along a length of a barrel of the extruder system.

18. The method of claim 17, wherein the extruder system includes a plurality of feeds disposed along the length of the barrel, and wherein the solvent and the at least one of chitosan, chitin, or chitosan oligosaccharide are fed into the extruder system through separate feeds in the plurality of feeds.

19. (canceled)

20. The method of claim 11, wherein the dispersed phase includes at least one of chitin, starch, or cellulose.

21-31. (canceled)

32. A method of foam extrusion, comprising:
feeding a solvent means into an extruder system;
feeding matrix material means into the extruder system;
feeding dispersed phase means into the extruder system; and
outputting from the extruder system a foam means including the dispersed phase means.

33. The method claim 32, wherein the extrusion system has parameters including including a barrel heating profile, and screw speed.

34-49. (canceled)
